(19) United States
(12) Patent Application Publication
(10) Pub. No.: US 2015/0018730 A1
(43) Pub. Date: Jan. 15, 2015

(54) Method of Pain Management via Mechano-Receptor Treatment on Inverse Linked Neuro-Receptors of the Spinal Column

(71) Applicant: Jennifer Jinus Tinoosh, Lynchburg, VA (US)

(72) Inventor: Jennifer Jinus Tinoosh, Lynchburg, VA (US)

(21) Appl. No.: 14/326,349

(22) Filed: Jul. 8, 2014

Related U.S. Application Data
(60) Provisional application No. 61/843,704, filed on Jul. 8, 2013.

(51) Int. Cl. A61H 1/00; G09B 23/30

(52) U.S. Cl. CPC A61H 1/008; G09B 23/30
USPC 601/107

(57) ABSTRACT

A method of pain management via mechano-receptor treatment on inverse linked neuro-receptors of the spinal column is provided as an indirect means of treating localized pain through the administration of remote mechanical stimulation. The method accomplishes this through a step wise process that determines an affected area on a patient's body and references the area to a known pairing of regions to determine the corresponding remote treatment area. The method is optionally suited for the treatment of nerve or motor control related pain, joint site related pain, muscle or tendon condition related pain, as well as unspecific localized pain. The method utilizes the understanding of dermatome regions in order to create a dermatome treatment pair, where an affected dermatome region corresponds to a treatment dermatome region.

The current application claims a priority to the U.S. Provisional Patent application Ser. No. 61/843,704 filed on Jul. 8, 2013.

### FIELD OF THE INVENTION

The present invention relates generally to a chiropractic treatment protocol, more specifically to a chiropractic treatment protocol that is designed to treat neuro-musculo-skeletal disorders to alleviate symptoms of pain and increase range of motions through mechanical-percussing adjusting instrument.

### BACKGROUND OF THE INVENTION

Pain is perceived within the frontal cortex of the brain by transfer of neurological pathways from the source of stimuli to alarm the body that something is wrong. Pain is the most common reason patients consult with their physicians. More than 26 million Americans between the ages of 20-64 experience frequent back pain. It is estimated that 20% of American adults (42 million people) report pain or physical discomfort as the cause of sleep disturbances a few nights a week or more. It is known that pain is a significant public health problem as it costs society at least $560-$635 billion annually. The invented method of treatment targets mechanical disorders of neuro-musculo-skeletal system.

There are two types of nociceptors (pain receptors), and the differences between them can easily be understood. Let's say that you tripped and fell, landing hard on one knee. You would experience an acute, well-localized, painful sensation in your knee, followed by a dull and aching sensation. This reflects the two types of fiber systems that conduct pain from the periphery into the central nervous system. The first pain signals are carried by A-delta fibers, which are insulated with myelin, protein filled fatty layers and therefore conduct rapidly. The longer-lasting pain signals are carried by C-fibers, which are unmyelinated and conduct slowly.

Chemical agents that do not activate nociceptors can also produce sensitization. The best known of these agents are prostaglandins, which appear when tissues are inflamed by infection, arthritis, or other factors. Their synthesis depends on the enzyme cyclooxygenase. This enzyme is inhibited by many of the medicines that are used to treat pain: aspirin, acetaminophen, ibuprofen, and the new cyclooxygenase 2 selective drugs, celecoxib (Celebrex) and rofecoxib (Vioxx). These drugs are particularly effective for pain associated with sensitization and are better for tenderness than for continuous severe pain.

The central nervous system's pain transmission neurons can also become sensitized in a way similar to the primary afferent nociceptors. This process is called central sensitization, and it is set in motion by neurotransmitter chemicals released at the central terminals of nociceptors. Thus, when a person is injured, the subsequent activity of nociceptors produces a bigger and bigger response in pain transmission pathways; pain begets further pain, even if the stimulus that triggered the response remains the same.

Pain is treated by the following treatment methods: allopathically via analgesics and/or anti-inflammatories or other exogenous chemical agents, surgical intervention, physical medicine such as chiropractic and physical therapy. The most beneficial effective order of treatment should be physical medicine first and if needed combining exogenous chemical agents, then as a last resort, surgical intervention. When treating pain, physical medicine should always be the first method since it deals directly to rehabilitating the injured area as opposed to exogenous medicine which mostly blocks the communication between the injured area and the central nervous system, mainly the brain.

Conventional chiropractic follows the knowledge of basic neurology, such as dermatome, which are areas of skin that are neurologically supplied from sensory nerve fibers from a single spinal nerve, or myotome, a group of muscles neurologically supplied by a single spinal nerve, or conventional anatomy such that when range of motion is limited in a joint due to pain or dysfunction, conventional chiropractic will treat the pain at/or around the site of pain.

In conventional chiropractic via manipulative procedures, nerve receptors are activated by mechanical stimulation at either the site where spinal vertebrae interlock or they are activated at the joints of the limbs or peripherals. Physiologically, within this type of treatment, pain receptors become inactive or less active, resulting in increased range of motion at the desired site and decreased pain level. Based on the dermatomal regions, conventional chiropractic methods treat numbness and tingling or similar neurological disorders that are affected by the dysfunction of body mechanics. However, many times going to site of pain and mechanically manipulating the area, the patient will have adverse reactions to the treatment. As a patient may have reduced or increased sense of to touch or sensation, inflammation, hypersensitivity, or an increased sensitivity to pain, when you treat patient the defensive mechanism of the symptomatic area causes tension at the site, hence exerting manipulation or motion becomes challenging for the doctor and painful for the patient.

It is therefore the object of the present invention to provide a chiropractic treatment protocol that is designed to balance the mechanics of forces that pull the body musculatures to one side verses the other side, hence causing sprain, strain, excessive muscle tension, and/or fatigue of soft tissue manifesting as pain and neuro-musculo-skeletal dysfunction within patients. The present invention focuses on the pain remotely, treating mechanically at the joint diagonally positioned from the symptomatic joint. This is based on theory of four forces to assure zero pressure at the center of forces, resulting in restored balance posture and full range of motion. The treatment method of the present invention is performed at a sister nerve root level to treat disorders associated with nerve root patterns, or areas neurologically supplied by peripheral nerves, so that a shockwave or wave of forces, travels without any mechanical imbalance within the body movement from one point to another, improving daily activities of the patient. The treatment method of the present invention balances the vertical plane that divides the body into front and back portions, the vertical plane that divides the body into right and left sections and the horizontal plane that divides the body into a top section and bottom section to zero force pressure by stimulating nerve receptors remotely through a diagonal pathway of forces at the opposite corner of the plane.

### BRIEF DESCRIPTIONS OF THE DRAWINGS

FIG. 1 is an anterior view displaying the positioning of the dermatome regions on a human body.

FIG. 2 is a posterior view displaying the positioning of the dermatome region on the human body.

FIG. 3 is a frontal view displaying the separation of the superior region and the inferior region on the human body as per the current embodiment of the present invention.

FIG. 4 is front view displaying the inverse and contralateral arrangement of the point of pain and the point of treatment as per the current embodiment of the present invention.

FIG. 5 is a block diagram displaying the process overview of the method of pain management via mechano-receptor treatment on inverse linked neuro-receptors of the spinal column.

FIG. 6 is a block diagram displaying the process overview of nerve or motor control related pain as well unspecific localized pain as per the current embodiment of the present invention.

FIG. 7 is a block diagram displaying the process overview of managing joint site related pain as per the current embodiment of the present invention.

FIG. 8 is a block diagram displaying the process overview of managing muscle or tendon condition related pain as per the current embodiment of the present invention.

### DETAIL DESCRIPTIONS OF THE INVENTION

All illustrations of the drawings are for the purpose of describing selected versions of the present invention and are not intended to limit the scope of the present invention.

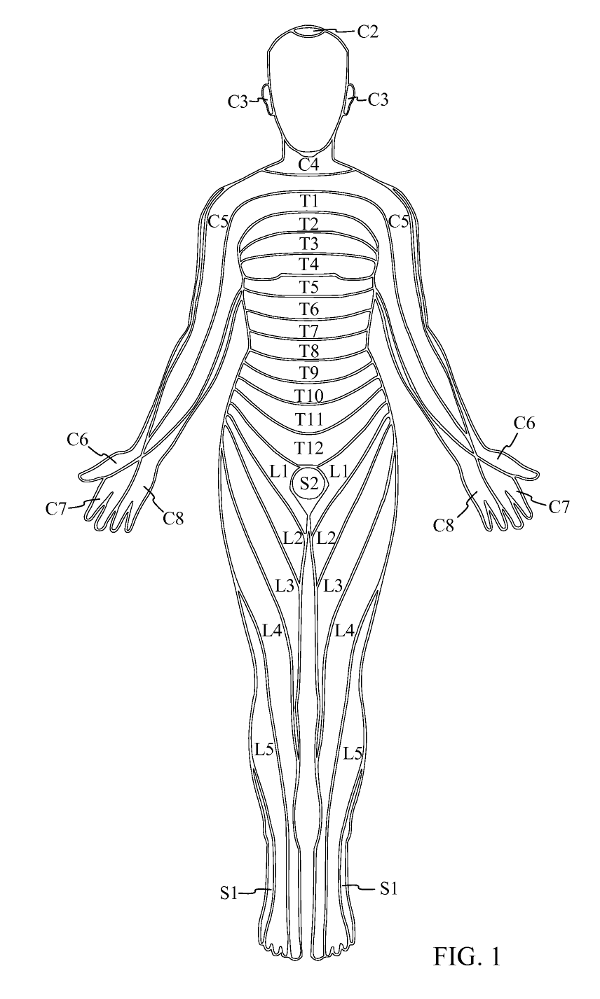

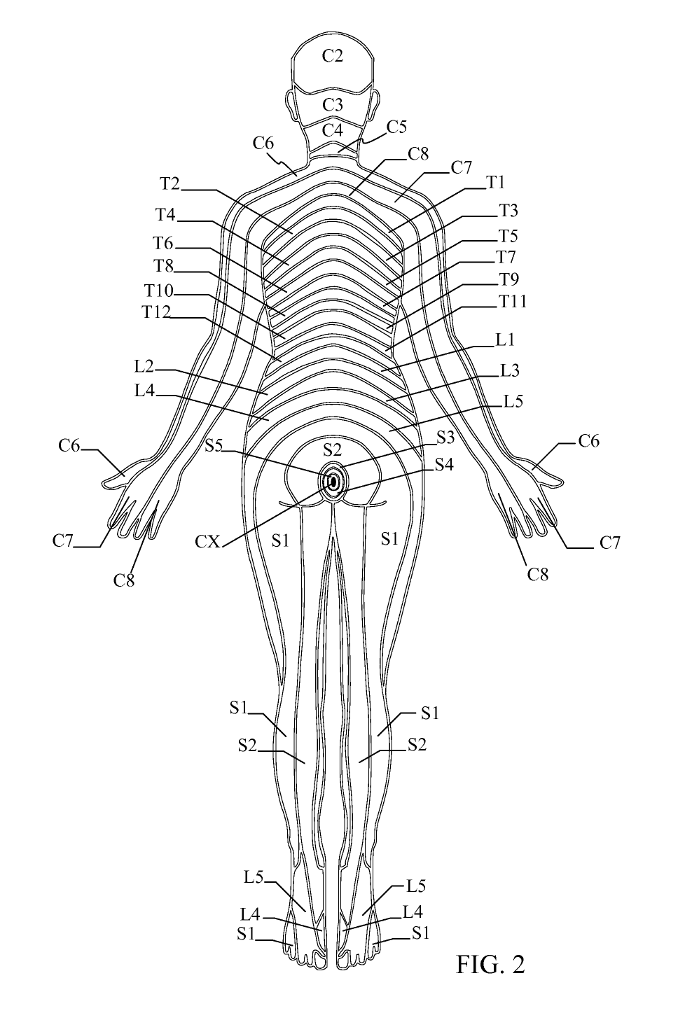

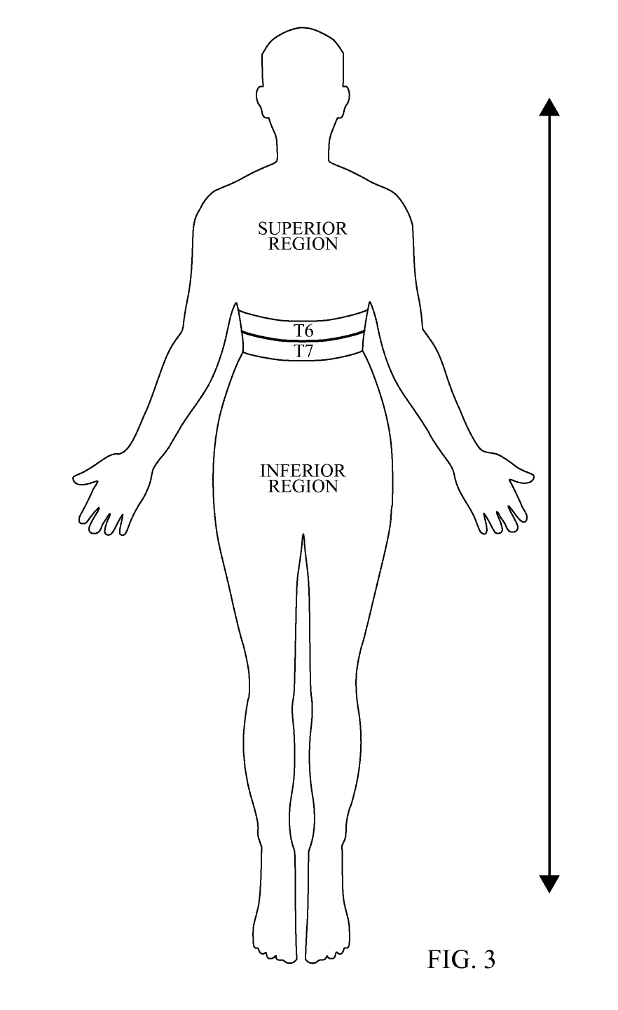

Referencing FIG. 1-4, the present invention is a chiropractic treatment method for pain management that is able to remotely treat a region of pain or discomfort on the human body. The preset invention accomplishes by administrating mechanical stimulation inversely and contralaterally to the region of pain or discomfort. The remote administration of mechanical stimulation relieves pain caused by a plurality of reasons and through the understanding of the theory of four forces which assure zero pressure at the center of force, resulting in restored balanced posture and a full range of motion. In the current embodiment of the present invention, the treatment method is provided with the understanding of dermatome regions as they relate to regions on a patient's body. Referencing FIG. 1 and FIG. 2, dermatome regions on the patient's body that are known to relate to particular nerve ending extending from the spinal cord. Additionally the human body is further divided in the method by the acknowledgement of a superior region and an inferior region along the superior-inferior axis. Referencing FIG. 3, the superior region and the inferior region are separated by the coincident edge of the T6 dermatome region with the T7 dermatome region. The superior region extends from the cranium towards the coincident edge of the T6 region, while the inferior region extends from the coincident edge of the T7 region towards the patient's feet. The division of the superior region and the inferior region provides distinct contralaterally positioned points of treatment based on the identified points of pain. The utilization of the dermatome regions permits a direct reference for indentifying a point of pain 10 and determining its corresponding point of treatment 20.

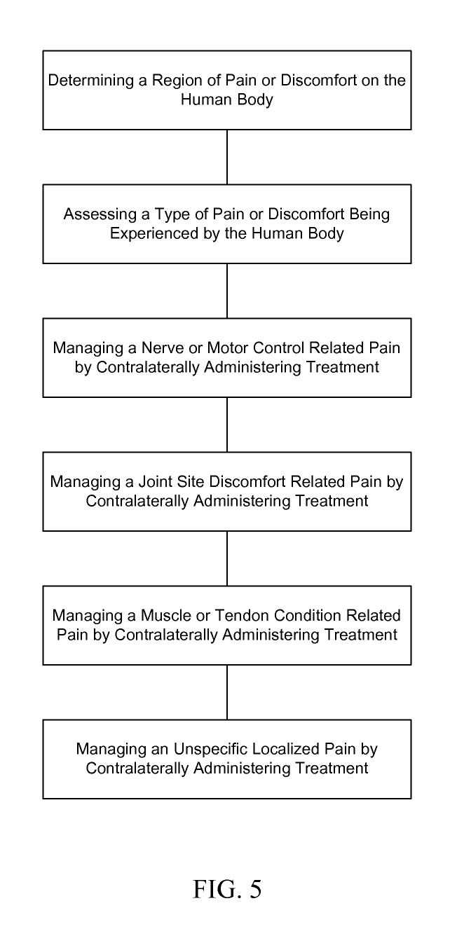

Referencing FIG. 5, in the current embodiment of the present invention, the method of pain management via mechano-receptor treatment of inverse linked neuro-receptors of the spinal column comprises the steps of determining a region of pain or discomfort on the human body, assessing the type of pain or discomfort being experienced by the human body, and managing the pain on the superior region or the inferior region by contralaterally administering treatment on the inferior region or the superior region respectively. The determination of the region of pain or discomfort on the human body locates the particular region to which the pain or discomfort is associated with. The determination of the particular region of pain or discomfort is utilized in conjunction with the assessment of the particular type of pain or discomfort in order to determine a corresponding point of treatment 20 on the human body. The assessment of the type of pain is performed to determine if the patient is suffering from nerve or motor control related pain, joint site discomfort related pain, a muscle or tendon condition related pain, or an unspecified localized pain. The management of the pain is accomplished through the administration of treatment to an inverse and contralaterally positioned point of treatment 20 relative to the region of pain and to the type of pain or discomfort experienced at the point of pain 10.

The determination of a region of pain or discomfort is accomplished through interactions with the patient. The interaction with the patient would provide vital information for locating the particular region of pain or discomfort and as a result would enable a practitioner to then assess the type of pain or discomfort being experienced by the patient. The interactions with the patient may be accomplished through a medical assessment or survey, wherein the patient would provide the information regarding the point of pain 10 or discomfort as part of the medical assessment. It should be understood that the determination of the region of pain or discomfort can be accomplished through a plurality of means and that the importance of the step is for the localizing the region of pain or discomfort in order to later assess the type of pain being experienced by the patient.

The assessment of the type of pain being experienced by the patient is utilized in conjunction with the determination of the region of pain or discomfort to implement a treatment to a particular point of treatment 20. The assessment step makes the determination between four categories of pain which are location and interaction dependent. The four categories of pain comprise nerve or motor control related pain, joint site discomfort related pain, muscle or tendon condition related pain, and unspecific localized pain. Nerve or motor control related pain is pain associated with particular nerve endings that respond painfully to particular motions or actions. Nerve or motor control related pain is assessed by a practitioner through a plurality of assessment interaction that include, but are not limited to palpation of and/or stimulation of the region of pain or discomfort. Due to the particular nature of the nerve or motor control related pain, the point of pain 10 and the point of treatment 20 are closely associated with dermatome regions. As a result of this relation, regions of pain or discomfort caused by nerve or motor control related pains are directly correlated with dermatome regions. Similar to nerve or motor control related pain, unspecific localized pains such as non-muscular or joint related pains would also rely on dermatome regions. Unspecific localized pain can include headaches and non-muscular abdominal aches and pains. Joint site discomfort related pain is related to pain felt by a patient at a particular joint site during movement or following movement of the particular joint site. Joint site discomfort related pain does not rely on dermatome regions as many joint sites have comparable inversely and contra laterally positioned joint site that function as a point of treatment 20. Muscle or tendon condition related pains are pains related to particular muscle groups, connective tissue, or tendons as a result of an injury or motion. Muscle or tendon condition related pain do not specifically rely on dermatome regions for localization of point of pain 10 and point of treatment 20 although in many instances the point of pain 10 and point of treatments 20 will overlap with dermatome regions.

TABLE 1
Treatment Dermatome Pairing for Management
of Nerve or Motor Control Related Pain

| Point of pain | Point of treatment |
|---|---|
| C1 | COCCYX |
| C2 | SI SACROILIAC NERVE |
| C3 | L5 |
| C4 | L4 |
| C5 | L3 |
| C6 | L2 |
| C7 | L1 |
| T1 | T12 |
| T2 | T11 |
| T3 | T10 |
| T4 | T9 |
| T5 | T8 |
| T6 | T7 |
| T7 | T6 |
| T8 | T5 |
| T9 | T4 |
| T10 | T3 |
| T11 | T2 |
| T12 | T1 |
| L1 | C7 |
| L2 | C6 |
| L3 | C5 |
| L4 | C4 |
| L5 | C3 |
| SI Sacroiliac Nerve | C2 |
| COCCYX | C1 |

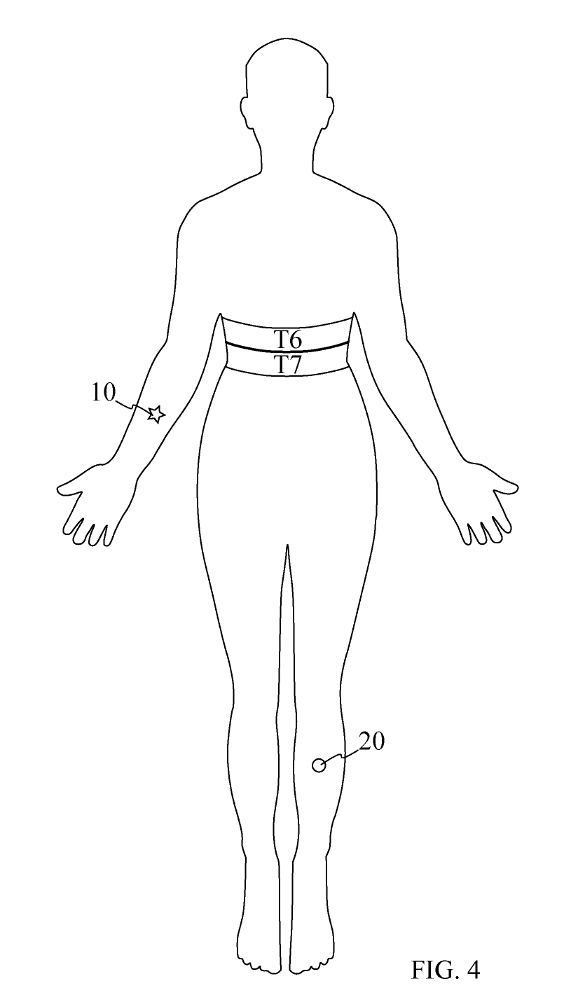

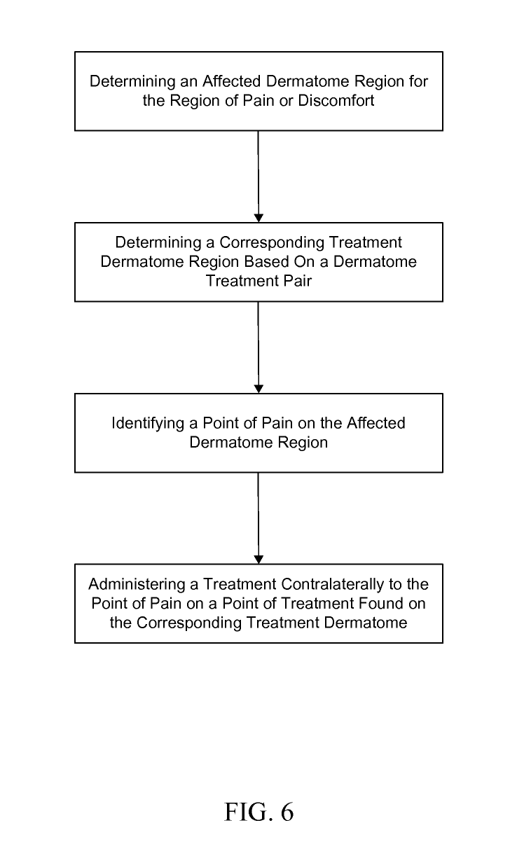

Referencing FIG. 4 and FIG. 6, in the current embodiment of the present invention, the management of nerve or motor control related pain is accomplished through inverse administration of treatment contralaterally on an opposing region on the superior-inferior axis. A point of pain 10 assessed as a nerve or motor control related pain is identified as being on either the superior region of the inferior region, at which point the point of treatment 20 is determined to be positioned contralaterally on the inverse region of the point of treatment 20, either the inferior region or the superior region, respectively. The management of nerve or motor control related pain is dependent on the determination of an affected dermatome region for the region of pain or discomfort experienced by the patient. The practitioner would determine the affected dermatome region by assessing the region of pain or discomfort and correlate the findings with the known distribution and positioning of dermatome regions. Upon determining an affected dermatome region, the practitioner would be able to determine a corresponding treatment dermatome region based on a dermatome treatment pair for nerve or motor control related pain. The dermatome treatment pair for nerve or motor control related pain is a relationship between dermatome regions positioned opposite the separation of the superior region and the inferior region. The dermatome treatment pair comprises a dermatome in the superior region and a dermatome in the inferior region. The understanding is provided that the opposing dermatomes are related and pain or discomfort to either region would be treatable through administration of a mechano-stimulation to the other paired dermatome. Following the identification of the corresponding treatment dermatome region, a point of pain 10 would be identified on the affected dermatome region. The point of pain 10 is found through palpation or through interactions with the patient. The identification of the point of pain 10 permits the identification of the point of treatment 20 on the corresponding treatment dermatome. The point of treatment 20 is contralaterally positioned to the point of pain 10 on the treatment dermatome. The administration of a treatment would be conducted by the practitioner to the point of treatment 20. Following administration the practitioner would verify the effectiveness of the treatment.

It should be noted that the treatment dermatome pairing comprising C1 and the Coccyx is provided with an understanding that the C1 cervical nerve has no associated dermatome region. C1 is unique as the C1 root innervates the meninges of the posterior fossa. A determination of the point of pain 10 being at C1 is particular to nerve or motor control related pain. As a result assessment of the type of pain is greatly important to ensure that proper administration of a treatment to a particular point of treatment 20. When determined as the point of treatment 20, treatment is administered to C1 nerve through the C2 dermatome region.

TABLE 2
Treatment Dermatome Pair for Management
of an Unspecific Localized Pain

| Point of pain | Point of treatment |
|---|---|
| C2 | COCCYX |
| C3 | SI SACROILIAC NERVE |
| C4 | L5 |
| C5 | L4 |
| C6 | L3 |
| C7 | L2 |
| C8 | L1 |
| T1 | T12 |
| T2 | T11 |
| T3 | T10 |
| T4 | T9 |
| T5 | T8 |
| T6 | T7 |
| T7 | T6 |
| T8 | T5 |
| T9 | T4 |
| T10 | T3 |
| T11 | T2 |
| T12 | T1 |
| L1 | C8 |
| L2 | C7 |
| L3 | C6 |
| L4 | C5 |
| L5 | C4 |
| SI Sacroiliac Nerve | C3 |
| COCCYX | C2 |

Referencing FIG. 4 and FIG. 6, in the current embodiment of the present invention, the management of unspecific localized pain is accomplished through inverse administration of treatment contralaterally on an opposing region on the superior-inferior axis. Unspecific localized pain differs from the other categories of pain as it is related specifically to an area of skin or to a dermal region associated with a dermatome. The management of unspecific localized pain is approached similarly to the treatment of nerve or motor control related pain. Similarly the unspecific localized pain is identified as being associated with a point of pain 10 on an affected dermatome region on either the superior region of the inferior region. The identification of the point of pain 10 permits the identification of a point of treatment 20 positioned contralaterally on the inverse region being either the inferior region or the superior region, respectively. Similar to the management of nerve or motor control related pain, management of unspecific localized pain is dependent on the determination of an affected dermatome region. The affected dermatome region is the affected dermatome on which the region of pain or discomfort is being experienced by the patient. A practitioner would determine the affected dermatome region by assessing the complaints of the patient and correlating the region of pain or discomfort with the known distribution and positioning of dermatome regions. Upon determining an affected dermatome region, the practitioner would be able to determine a corresponding treatment dermatome region based on a dermatome treatment pair for unspecific localized pain. The dermatome treatment pair for the unspecific localized pain is a relationship between dermatome regions positioned opposite the separation of the superior region and the inferior region. The dermatome treatment pair comprises a dermatome in the superior region and a dermatome in the inferior region. The understanding is provided that the opposing dermatomes are related and pain or discomfort to either region would be treatable through administration of a mechano-stimulation to the other paired dermatome. Following the identification of the corresponding treatment dermatome region, a point of pain 10 would be identified on the affected dermatome region. The point of pain 10 is found through palpation or through interactions with the patient. The identification of the point of pain 10 permits the identification of the point of treatment 20 on the corresponding treatment dermatome. The point of treatment 20 is contralaterally positioned to the point of pain 10 on the treatment dermatome. The administration of a treatment would be conducted by the practitioner to the point of treatment 20. Following administration the practitioner would verify the effectiveness of the treatment.

It should be noted that the treatment dermatome pairs for the management of unspecific localized pain differs from the treatment dermatome pairs for the management of the nerve or motor control related pain at the dermatome site of the Coccyx. The treatment dermatome pair for the management of the nerve or motor control related pain is nerve specific while dermatome regions relate to dermal regions associated with the particular nerve ending. Resultantly, the dermatome treatment pair for the coccyx would be accomplished by the C1 nerve in the nerve or motor control treatment pair. In the unspecific localized pain treatment pair, the coccyx corresponds to the C2 dermatome region causing a shift for the treatment pairs. As a result, C3 is paired with the SI Sacroliac Nerve, C4 is paired with L5, C5 is paired with L4, C6 is paired with L3, C7 is paired with L2, and C8 is paired with L1.

TABLE 3
Joint Site Treatment Pair for Managing
Joint Site Discomfort Related Pain

| Point of pain | Point of treatment |
|---|---|
| Gleno-Humeral Joint | Acetabular Joint |
| Sterno-Clavicular Joint | Posterior Superior Illiac Spine |
| Ulnar-Humeral Joint | Fibulo -Femoral Joint |
| Radio-Humeral Joint | Tibio-Femoral Joint |
| Olcranon Process | Inferior Patella |
| Radio-Ulnar Joint | Tibio-Fibular Joint |
| Radial Site | Medial-Malleolus |
| Ulnar Site | Lateral-Malleolus |
| Scaphoid | Navicular |
| Lunate | Medial -Calcaneus |
| Triquetrum | Lateral Calcaneal |
| Hamate | Lateral Cuneiform |
| Trapezium | Intermedial Cuneiform |
| Trapezoid | Medial Cuneiform |
| Capitate | Cuboid |
| Meta-Carpo-Carpal Joint | Meta-Tarsal Joint |
| Meta-Carpo-Phalangeal | Meta-Tarso-Halux Phalangeal |
| Policis | Halux |
| Proximal Phalangeal | Pedal Proximal Phalangeal |

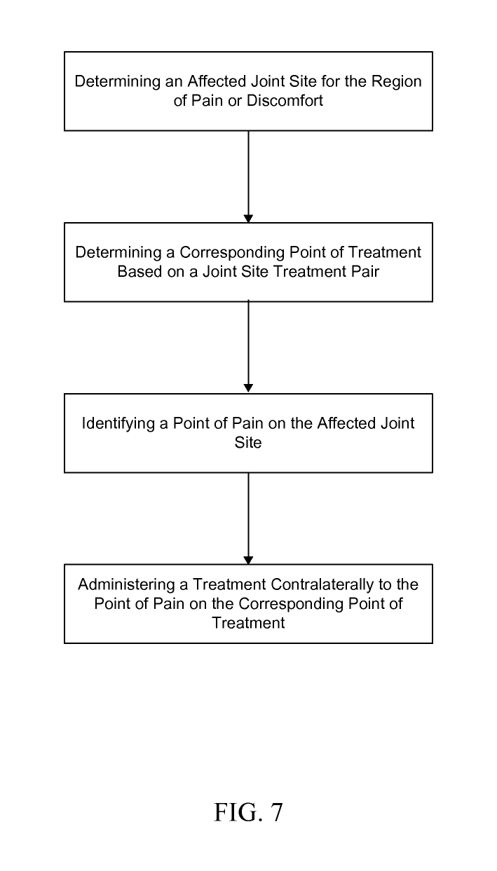

Referencing FIG. 4 and FIG. 7, in the current embodiment of the present invention, joint site discomfort related pain is related to pain felt by a patient at a particular joint site during movement or following movement of the particular joint site. Management of joint site discomfort related pain is accomplished utilizing the same principal as the nerve or motor control related pain and the unspecific localized pain, in that an affected region is remotely treated contralaterally and on an opposing region, relative to the superior region and inferior region. Unlike the management of the nerve or motor control related pain and the unspecific localized pain, the management of the joint site discomfort related pain does not rely on dermatome regions to identify a region of pain or discomfort. The management of the joint site discomfort related pain identifies particular joint sites as joint site treatment pairs. The joint site treatment pairs comprise an affected joint site and a treatment joint site. The joint site treatment pairs are positioned contralaterally and on opposing regions, either the superior region or the inferior region.

The management of the joint site discomfort related pain is accomplished through the determination of an affected joint site as the region of pain or discomfort. An affected joint site is indentified by a practitioner through a medical assessment that may include palpation of the region of pain or discomfort. The practitioner can additionally request the patient articulate the particular joint to make the determination. Upon the determination of the affected joint site as the region of pain or discomfort, the practitioner identifies a point of pain 10 on the affected joint site. The identification of the point of pain 10 provides specificity that helps in the administration of the treatment. Following the identification of the point of pain 10, the practitioner determines a corresponding point of treatment 20 to the point of pain 10 based on a joint site treatment pair. The joint site treatment pair allows a practitioner to determine the corresponding treatment joint site. The corresponding treatment joint site is utilized with the knowledge of the point of pain 10 to correctly identify the contralateral positioning of the point of treatment 20 on the corresponding treatment joint site. The practitioner administers mechanical stimulation to the treatment joint site as necessary. Following the administration of the mechanical stimulation, the practitioner reevaluates the patient to determine the effectiveness of the treatment.

It should be noted that the joint site treatment pairs comprise the Meta-Carpo-Carpal Joint paired with the Meta-Tarsal Joint, the Meta-Carpo-Phalangeal paired with the Meta-Tarso-Halux Phalangeal, the Proximal Phalangeal paired with the Pedal Proximal Phalangeal, and the Distal Phalangeal paired with the Distal Pedal Phalangeal. The aforementioned joint site treatment pairs are each related to a particular digit of the users hand or foot. It should be understood that the joint pairing would correspond to the particular joint on the corresponding digit of the patients hand or foot such that the affected joint site on the Meta-Carpo-Carpal Joint of the first digit on the patients hand would correspond with the Meta-Tarsal Joint of the first digit on the patient's foot.

In the current embodiment of the present invention, the management of joint site discomfort is provided with a join site treatment triplet for particular joint sites. It has been observed that the particular administration of mechanical stimulation to two remote treatment joint sites for a particular affected joint site has achieved favorable treatment outcomes. The particular joint sites in question comprise the Temporomandibular Joint (TMJ), the Hip Joint, and the shoulder. A particular relationship has been determined between the temporomandibular joint and the shoulder, where treatment administration on either is ipsilateral to one another. For instance, an identification of the point of pain 10 on the right temporomandibular joint would result in an ipsilater point of treatment 20 on the right shoulder, but a contralateral point of treatment 20 on the hip joint. Furthermore, in another example, the identification of the point of pain 10 on the right hip joint would result in a contralateral point of treatment 20 for both the shoulder and the temporomandibular joint.

In the current embodiment of the present invention, the management of joint site discomfort related pain additionally comprises the directional treatment administration to a treatment joint site. Directional treatment administration is provided to particular join site treatment pair comprising the acromioclavicular joint and the anterior iliac spine. The direction treatment administration is provided when the point of pain 10 is determined on the acromiclavicular joint. It has been determined that the administration treatment to the anterior iliac spine produces the most favorable results when a mechanical stimulation is administered to the anterior iliac spine from the anterior superior iliac spine towards the anterior inferior iliac spine.

TABLE 4
Muscle or Tendon Treatment Pair for Managing
a Muscle or Tendon Condition Related Pain

| Point of pain | Point of treatment |
|---|---|
| Knee Flexors | Elbow Flexors |
| Knee Extensors | Elbow Extensors |
| Knee Internal Rotators | Elbow External Rotators |
| Knee External Rotators | Elbow Internal Rotators |
| Wrist Flexors | Ankle Plantar Flexors |
| Wrist Extensors | Ankle Dorsiflexors |
| Wrist Medial Flexors | Ankle Pronators |
| Wrist Lateral Flexors | Ankle Supinators |
| Shoulder Flexors | Hip Extensors |
| Shoulder Extensors | Hip Flexors |
| Shoulder Abductors | Hip Abductors |
| Shoulder Adductors | Hip Adductors |
| Shoulder Internal Rotators | Hip Extrnal Rotators |
| Shoulder External Rotators | Hip External Rotators |
| Neck Flexors | Lumbar Flexors |
| Neck Extensors | Lumbar Extensors |
| Cervical Rotators (SCM) | Ipsilateral Illiopsoa Muscle Insertion |
| Supra Spinatus | Gluteus Medius |

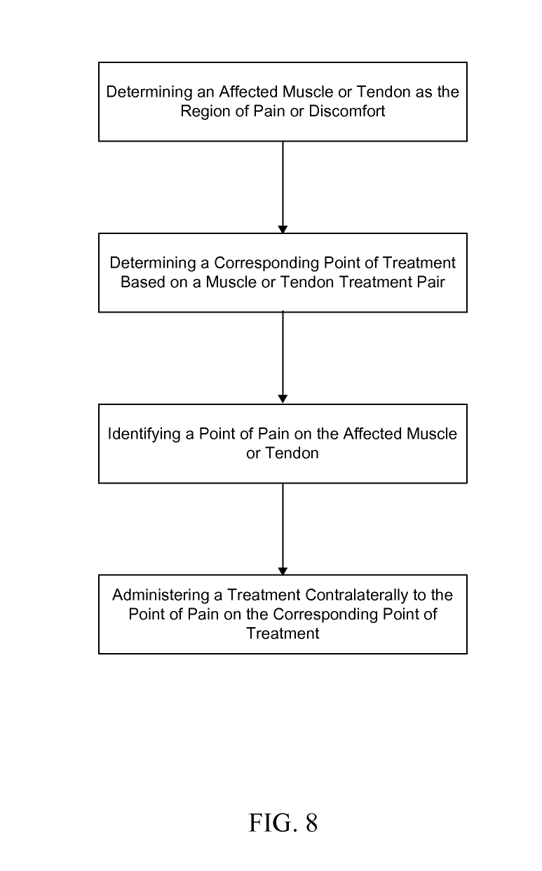

Referencing FIG. 4 and FIG. 8, in the current embodiment of the present invention, the management of muscle or tendon condition related pain is provided as a means of treating pains related to particular muscle groups, connective tissue, or tendons as a result of an injury or particular range of motion. Management of muscle or tendon condition related pain is accomplished through remote administration of treatment on the contralateral and inverse location to the region of pain or discomfort on a patient's body. Due to the points of pain and the points of treatment being derived from muscle or tendon conditions, the management of pain is greatly dependent on an understanding of the skelatol-muscular system. The treatment pair for the muscle or tendon condition related pains is based on muscle or tendon sites that are inverse and contralaterally positioned to one another. Additionally, an affected muscle or tendon site can be activated and treated by a particular range of motion. A practitioner determines an affected muscle or tendon as the region of pain or discomfort through a medical assessment that can include palpation to the muscle or tendon as well as requesting the patient to move in a particular manner to illicit the particular pain response. Following the determination of the affected muscle or tendon, the practitioner would identify the particular point of pain 10 on the affected muscle or tendon. The identification of the point of pain 10 is necessary as the means of determining the particular point of treatment 20. The particular point of treatment 20 is determined through a corresponding muscle or tendon treatment pair. The muscle or tendon treatment pair comprises an affected muscle or tendon as well as a corresponding treatment muscle or tendon. The muscle or tendon treatment pairs are contralaterally and inversed positioned to one another. When an affected muscle or tendon is found on an extremity, the corresponding treatment muscle or tendon is found contralateral and an opposing limb. Following the identification of the corresponding treatment muscle or tendon, the practitioner administers the mechanical stimulation to the treatment muscle or tendon on the corresponding point of treatment 20. After the treatment is administered, the practitioner reevaluates the patient to ensure the effectiveness of the treatment.

In the current embodiment of the present invention, the point of pain 10 on an affected muscle or tendon may be directionally activated with a particular bias in movement. The particular bias in the direction of activation for the affected muscle or tendon would be such that a clockwise rotation would activate the point of pain 10. In the aforementioned example, administration of a counter directional movement on the point of treatment 20 would be deemed appropriate on the corresponding treatment muscle or tendon associated with the affected muscle or tendon on which the point of pain 10 is found on. In an embodiment of the present invention, generalized neck pain upon rotation in cervical paraspinal is alleviated through the rotation of the lumbar to the opposite side and treating the lumbar paraspinalis. Similarly, the treatment of a cervical paraspinal pain upon lateral (right or left) bending is treated through a bend at the lumbar spine to the opposite direction of the cervical lateral bending that causes the pain and would include mechanical stimulation/manipulation on the lumbar paraspinal to the side of bending in order to alleviate pain.

In the current embodiment of the present invention, headaches are treatable through complimentary locations on the navel region. Frontal headache are treatable through the administration of treatment to a region one inch above the naval and one inch lateral each way going across. Coronal headaches are treatable through the administration of treatment to the sacro coccyxgeal area. Furthermore, parietal headaches are treatable through the administration of contralateral stimulation to the gluto-acetabular region.

The chiropractic treatment method for pain management is able to remotely treat an affected area of a patient's body. The preset invention accomplishes this through a method for administrating mechanical stimulation at a position that is diagonal from the affected region. The remote administration of mechanical stimulation relieves pain caused by a plurality of reasons and through the understanding of the theory of four forces, assure zero pressure at the center of force, resulting in restored balanced posture and a full range of motion. In the current embodiment of the present invention, the treatment method utilizes dermatome regions in order to distinguish the pain regions as well as subsequent treatment regions. It should be noted that while dermatome regions are utilized in the present invention, the current embodiment utilizes a novel interpretation of the dermatome regions that provides facilitated identification of pain/discomfort areas as well as contra-laterally treatment regions. Furthermore it should be noted that treatment regions are dependent on the type of pain that is experienced by the user.

The treatment method comprises the steps of determining the region of pain or discomfort, assessing the patient's type of discomfort, determining contra-laterally positioned treatment region on the patient's body, administering the treatment to the patient, and reevaluating the patient's condition. The determination of the region of pain or discomfort is provided as the step of the method that associates a patient's discomfort with a particular dermatome region. The assessment of the patient's pain is provided as the step of the method that determines the type of pain/discomfort the patient is feeling. The determination of the contra-lateral positioning of the treatment region on the patient's body is provided as an identifying step for determining the contra-lateral position of treatment administration based on the type of pain and the associated pain region. The administration of the treatment to the patient is provided as the step of the method that mechanical stimulation would administered to the determined treatment region. The revaluation of the patient is provided as the step of the method that assesses the success of the treatment. Through the combination of the aforementioned method steps, the treatment method would provide an alternative pain management treatment.

The method step of determining the region of pain or discomfort for a patient is the step that is utilized to locate the region that the patient is experiencing discomfort. During the step, a practitioner would assess the patient's general complaint and utilize a dermatome diagram and their anatomical knowledge to make a determination regarding the patient's specific area of discomfort. Additionally the practitioner would utilize their knowledge to make determination regarding joint sites as well as muscle and tendon site to administer treatments. It should be noted that compound injuries and a combination of various injuries would be taken into account and a practitioner may utilizes their discretion to determine on which region of discomfort to focus on first.

The method step of assessing the patient's type of discomfort is the step that is utilized to determine if the patient is experiencing pain/discomfort that is related with nerve and motor control issues or if the patient is experiencing discomfort due to a particular dermatome. During the step, the practitioner would utilize the patient's medical history and exam the patient's region of discomfort to make the determination regarding what type of pain the patient is feeling. It should be noted that the determination step for locating the patient's region of discomfort is a prerequisite step for evaluating the patient's pain type, as the type of pain may be essential in determining the corresponding treatment region for the patient's particular pain.

The method step of determining the contra-laterally positioned treatment region on the patient's body is provided as the step where the practitioner utilizes the prior steps and their knowledge to locate the treatment region based on Table 1-4. During the step, the practitioner would evaluate the region of discomfort and the pain type and reference Table 1 and Table 2 to determine the contra laterally positioned treatment location. Additionally the practitioner would utilize Table 3 and Table 4 to make determinations regarding discomfort felt in particular joint sites and muscle and tendon regions.

The method step of administering the treatment to the patient is provided as the step where the practitioner administers mechanical stimulation to the determined treatment location. During the step the practitioner would administer mechanical stimulation as need to the pre-determined treatment location wherein the duration and intensity of the mechanical stimulation would be dependent of the intensity and type of discomfort felt by the patient. It should be noted that the duration and intensity of the mechanical stimulation would be influenced by the practitioner's knowledge of the patient's particular condition and could deviate as needed in order to accommodate the patient's needs.

The method step of reevaluating the patient's condition is provided as the step where the practitioner determines the success of the treatment and the further determines a treatment schedule for the patient. During the step the practitioner evaluates the treatment's effectiveness by determining changes to the patient's initial complaints; results are normally seen immediately after administering the treatment. Typically the results will show a 20-30% improvement in range of motion complaints and a noticeable difference in dermatome, joint, and muscle and tendon pain. It should be noted that the practitioner may additionally recommend follow up visits as needed at this point.

The sagittal plane is utilized in order to function as a dividing plane that separates the right and left side of the body. The division provides the treatment method with a mid line in order to establish diagonally positioned points from right to left, left to right, top to bottom, and bottom to top. In accordance with the current embodiment of the present invention, discomfort felt in the upper thorax, or the area between the neck and diaphragm which is incased by the ribs and mid-spine, is treated by the lower thorax. Similarly, the cervical-occipital region, or neck area, is treated by the lumbo-sacro-coccygeal region or the lower region of the spine-triangular bone at the end of the spine. Additionally, the cranium region is treated by the lower gluteal or abdominal region and the upper extremities are treated by the lower extremities and vice versa.

The treatment method locates site of pain from patient, as well as what aggravates or amplifies the pain. Once point of pain 10 and amplifiers are determined, the treatment method stimulates the neuro-mechano receptors using a chiropractic instrument used to treat joint, nerve, and muscular systems via repetitive pulsations. At the opposite point of the sagittal plane as described above. An example of this situation would be if a patient is complaining of pain within the upper extremity region, the treatment method would stimulate the neuro-mechano receptors at the opposite plane point within the lower extremity region on the opposite side of the body.

Within spinal articular fixation or lesions, which is a mechanical dysfunction within the spinal joints, the treatment method would focus on the zygapophyseal joints at the sister vertebrae to treat mechanical derangement. For neurological disorders such as numbness or tingling known as paresthesia or weak muscles due to poor innervation, the treatment method would be administered at the sister nerve root to balance the axoplasmic flow of the nerve pattern, which is basically the circulation of fluid between the cell body of a neuron to the tail of the same neuron, known as the axon or the terminal process of a neuron.

In the current embodiment of the present invention, the treatment method activates the muscle spindle (stretch receptor) by stretching the muscle on the opposite plane within the opposite extremity region. By stretching the opposite plane muscle within the opposite extremity region, the stretched muscle communicates signals to the injured muscle spindle that increases range of motion and decreases pain. A similar phenomenon applies at the spinal level between the sister vertebral joints via stimulating the proprioceptors, which are nerve receptors associated with movement and position of the body. When treatment is administered to the sister vertebrae, the misaligned vertebrae regains increased range of motion and the patient experiences pain relief.

Although the invention has been explained in relation to its preferred embodiment, it is to be understood that many other possible modifications and variations can be made without departing from the spirit and scope of the invention as hereinafter claimed.

What is claimed is:

1. A method of pain management via mechano-receptor treatment on inverse linked neuro-receptors of the spinal column comprises the steps of:
providing a superior region and an inferior region on a human body, wherein the superior region and the inferior region are separated by the coincident edge of the T6 dermatome region with the T7 dermatome region;
determining a region of pain or discomfort on the human body;
assessing a type of pain or discomfort being experienced by the human body, wherein the type of pain or discomfort comprise nerve or motor control related pain, joint site discomfort related pain, a muscle or tendon condition related pain, or an unspecified localized pain;
managing a nerve or motor control related pain on the superior region or inferior region by contralaterally administering treatment on the inferior region or the superior region, respectively;
managing a joint site discomfort related pain on the superior region or inferior region by contralaterally administering treatment on the inferior region or the superior region, respectively;
managing a muscle or tendon condition related pain on the superior region or the inferior region by contralaterally administering treatment on the inferior region or the superior region, respectively; and
managing an unspecific localized pain on the superior region or inferior region by contralaterally administering treatment on the inferior region or the superior region, respectively.

2. The method of pain management via mechano-receptor treatment on inverse linked neuro-receptors of the spinal column as claimed in claim 1 comprises the steps of:
determining an affected dermatome region for the region of pain or discomfort;
determining a corresponding treatment dermatome region based on a dermatome treatment pair;
identifying an point of pain on the affected dermatome region; and
administering a treatment contralaterally to the point of pain on a point of treatment found on the corresponding treatment dermatome.

3. The method of pain management via mechano-receptor treatment on inverse linked neuro-receptors of the spinal column as claimed in claim 2, wherein the treatment dermatome pair for managing nerve or motor control related pain comprise:
C1, Coccyx; C2, SI Sacroliac Nerve; C3, L5; C4, L4; C5, L3; C6, L2; C7, L1; T1, T12; T2, T11; T3, T10; T4, T9; T5, T8; T6, T7.

4. The method of pain management via mechano-receptor treatment on inverse linked neuro-receptors of the spinal column as claimed in claim 2, wherein the treatment dermatome pair for managing an unspecific localized pain comprise:
C2, Coccyx; C3, SI Sacroliac Nerve; C4, L5; C5, L4; C6, L3; C7, L2; C8, L1; T1, T12; T2, T11; T3, T10; T4, T9; T5, T8; T6, T7.

5. The method of pain management via mechano-receptor treatment on inverse linked neuro-receptors of the spinal column as claimed in claim 1 comprises the steps of:
determining an affected joint site for the region of pain or discomfort;
determining a corresponding point of treatment based on a joint site treatment pair;
identifying a point of pain on the affected joint site; and
administering a treatment contralaterally to the point of pain on the corresponding point of treatment, wherein the point of treatment is found on a corresponding treatment joint as per the joint site treatment pair.

6. The method of pain management via mechano-receptor treatment on inverse linked neuro-receptors of the spinal column as claimed in claim 5, wherein the joint site treatment pair for managing joint site discomfort related pain comprises:
Gleno-Humeral Joint, Acetabular Joint; Sterno-Clavicular Joint, Posterior Superior Illiac Spine; Ulnar-Humeral Joint, Fibulo-Femoral Joint; Radio-Humeral Joint, Tibio-Femoral Joint; Olcranon Process, Inferior Patella; Radio-Ulnar Joint, Tibio-Fibular Joint; Radial Site, Medial-Malleolus; Ulnar Site, Lateral-Malleolus; Scaphoid, Navicular; Lunate, Medial-Calcaneus; Triquetrum, Lateral Calcaneal; Hamate, Lateral Cuneiform; Trapezium, Intermedial Cuneiform; Trapezoid, Medial Cuneiform; Capitate, Cuboid; Meta-Carpo-Carpal Joint, Meta-Tarsal Joint; Meta-Carpo-Phalangeal, Meta-Tarso-Halux Phalangeal; Policis, Haluax; Proximal Phalangeal, Pedal Proximal Phalangeal; Distal Phalangeal, Distal Pedal Phalangeal.

7. The method of pain management via mechano-receptor treatment on inverse linked neuro-receptors of the spinal column as claimed in claim 5 comprises:
a joint site treatment triplet comprising the Temporomandibular Joint (TMJ), Hip Joint, and shoulder;
wherein point of pain on TMJ corresponds to ipsilateral point of treatment on the shoulder and a contralateral point of treatment on the hip joint;
wherein point of pain on the shoulder corresponds to ipsilateral point of treatment on TMJ and a contralateral point of treatment on the hip joint; and
wherein point of pain on the hip join corresponds to contral lateral point of treatment on the shoulder and contra lateral point of treatment on TMJ.

8. The method of pain management via mechano-receptor treatment on inverse linked neuro-receptors of the spinal column as claimed in claim 5 comprises:
directional treatment administration to a point of treatment for a joint site treatment pair, wherein the joint site treatment pair comprises acromioclavicular joint and the anterior iliac spine; and
wherein point of pain on the acromioclavicular joint corresponds to directional treatment administration to the anterior iliac spine from the anterior superior iliac spine to the anterior inferior iliac spine.

9. The method of pain management via mechano-receptor treatment on inverse linked neuro-receptors of the spinal column as claimed in claim 1 comprises the steps of:
determining an affected muscle or tendon as the region of pain or discomfort;
determining a corresponding point of treatment based on a muscle or tendon treatment pair;
identifying a point of pain on the affected muscle or tendon; and
administering a treatment contralaterally to the point of pain on the corresponding point of treatment.

10. The method of pain management via mechano-receptor treatment on inverse linked neuro-receptors of the spinal column as claimed in claim 9, wherein the muscle or tendon treatment pair for managing a muscle or tendon condition related pain comprise:
Knee Flexors, Elbow Flexors; Knee Extensors, Elbow Extensors; Knee Internal Rotators, Elbow External Rotators; Knee External Rotators, Elbow Internal Rotators; Wrist Flexor, Ankle Plantar Flexors; Wrist Extensors, Ankle Dorsiflexors; Wrist Medial Flexors, Ankle Pronators; Wrist Lateral Flexors, Ankle Supinators; Shoulder Flexors, Hip Extensors; Shoulder Extensors, Hip Flexors; Shoulder Abductors, Hip Abductors; Shoulder Adductors, Hip Adductors; Shoulder Internal Rotators, Hip External Rotators; Shoulder External Rotators, Hip External Rotators; Neck Flexors, Lumbar Flexors; Neck Extensors, Lumbar Extensors; Cervical Rotators (SCM), Ipsilateral Illiopsoa Muscle Insertion; Supra Spinatus, Gluteus Medius; Coronal Headaches, Sacro Coccyxgeal area; Parietal headaches, Gluto-Acetabular region.
